(19) United States
(12) Patent Application Publication
(10) Pub. No.: US 2006/0031272 A1
(43) Pub. Date: Feb. 9, 2006

(54) Alignment shifter supporting multiple precisions

(75) Inventors: Sang Hoo Dhong, Austin, TX (US); Hwa-Joon Oh, Austin, TX (US); Silvia Melitta Mueller, Altdorf (DE)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/912,480

(22) Filed: Aug. 5, 2004

(51) Int. Cl. G06F 7/00

(52) U.S. Cl. 708/209

(57) ABSTRACT

An apparatus, a method, and a computer program are provided for fully utilizing a double precision Floating Point (FP) alignment shifter. In conventional FP adders, and other FP computational units, double precision FP alignment shifters are utilized to perform both double and single precision alignment shifts. However, when a conventional double precision FP alignment shifter is utilized for a single precision calculation, half of the available capacity of the double precision FP alignment shifter is wasted. Therefore, to better utilize the capacity of double precision FP alignment shifter, a modified alignment shifter is utilized that can perform either an alignment shift for a double precision calculation or two simultaneous (or nearly simultaneous) alignment shifts for two single precision calculations.

### FIELD OF THE INVENTION

The present invention relates generally to a floating point unit (FPU), and more particularly, to the alignment shifter of an FPU.

### DESCRIPTION OF THE RELATED ART

As is widely known, a Floating Point Number (FPN) consists of a sign bit, an exponent, and a mantissa. There are two specific types of FPNs: single precision and double precision. Both single precision and double precision are defined as the standards set by the Institute for Electical and Electronic Engineers (IEEE). Single precision FPNs have one sign bit, eight exponent bits, and twenty-three mantissa bits with a one implicit bit. Double precision FPNs have one sign bit, eleven exponent bits, and fifty-two mantissa bits with one implicit bit. In conventional designs, though, the same logic is utilized to perform addition/subtraction for both single precision and double precision FPNs.

Conventional computational logic, however, can be categorically divided. Computational logic is typically divided into two types: multiply-add/subtract and distinct multiply and add/subtract. One of the more common methods associated with multiply-add/subtract FPN computation logic is based on three operands A, B, and C, such that the operation is A*B+C. For the FPN addition/subtraction to take place, the mantissas must be aligned. Therefore, in conventional system, FPNs require the use of an alignment shifter. Referring to FIG. 1 of the drawings, the reference numeral 100 generally designates a conventional alignment shifter for an addend to product alignment. The alignment shifter 100 is based on an alignment shifter for multiply-add/subtract FPU, but the alignment shifter 100 can be configured for use with an add/subtract FPU. The alignment shifter 100 comprises a shift amount calculator 102, a limiter 104, a shifter 106, and a multiplexer (mux) 108.

Specifically, floating point data is entered into the various components to determine the proper alignment. A first exponent (EA), a second exponent (EB), and a third exponent (EC) of three operands A, B, and C, respectively, are entered into both the limiter 104 and the shift amount calculator 104 through a first communication channel 110, a second communication channel 112, and a third communication channel 114, respectively. Correspondingly, there is a first mantissa (MA), a second mantissa (MB), and a third mantissa (MC) of the three operands correspond A, B, and C, respectively.

However, when computing the unbounded exponent difference between two FPNs, the difference can be very high. Depending on the computation and the precision, the difference can be in excess of 1000. These right-shift amounts are based on the exponents of the three operands EA, EB, and EC. Such wide shifts, however, are not necessary. Conventional designs account for the wide shifting by placing a limit on the shifting. Typically, the limit is place at three times the mantissa length (24 for single precision FPNs and 53 for double precision FPNs) plus some constant. For example, a limit can be 3n+2.

Once the shift amount calculator 102 receives the exponents of the three operands, then the shift amount calculation can be performed and transmitted. The shift amount, which is a right-shift amount, is then communicated to the shifter 106 through a fourth communication channel 122. The above amount will correspond to a right shift amount for the operant C. Hence, the third mantissa MC is communicated to the shifter 106 through a fifth communication channel 116. Additionally, the limiter 104 checks whether the unbounded shift amount overflows or underflows.

Once all of the shift and overflow/underflow calculations have been performed, the data is communicated to the mux 108 through a sixth communications channel 124. The limiter 104 provides a control signal to the mux 108 through a seventh communication channel 126 to allow for the mux 108 to provide the necessary correction for overflow or underflow. Additionally, the mux 108 also receives overflow and underflow data from the third mantissa, if necessary, through the fifth communication channel 116.

A problem associated with the conventional alignment shifter, though, is underutilization. Typically, a double precision aligner is used with both single precision FPNs and double precision FPNs. Thus, when single precision FPNs are used, then approximately one half of the double precision aligner is wasted. Because of the complicated procedures associated specifically with FPN addition/subtraction, the process of performing FPN operations can be time consuming. Hence, if the same logic is utilized for both single precision and double precision calculations, then a substantial amount of time may be lost if there are a number of single precision FPNs in queue.

Therefore, there is a need for a method and/or apparatus for properly utilizing all available logic that addresses at least some of the problems associated with conventional computation logic for FPNs.

### SUMMARY OF THE INVENTION

The present invention provides an apparatus for performing alignment shifts for a Floating Point operation. A double precision alignment shifter is employed. The double precision alignment shifter performs alignment shifts for a double precision operation or for two single precision FP operations.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting a conventional alignment shifter;

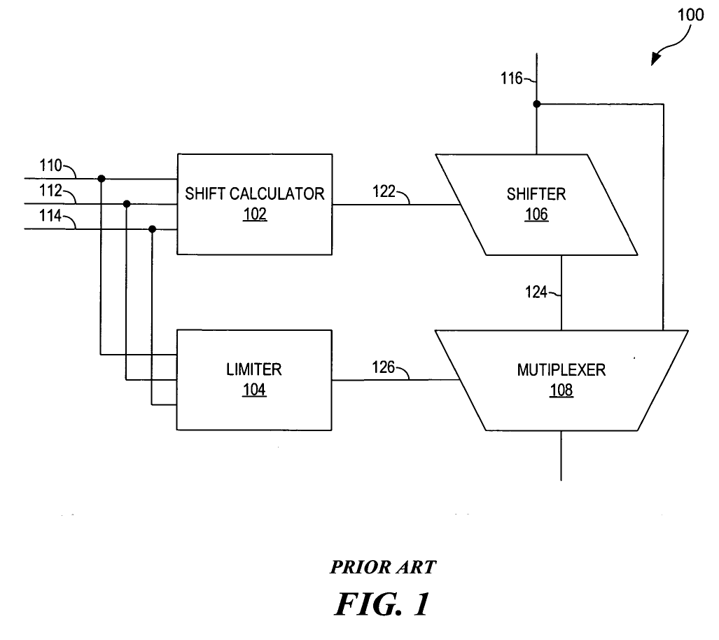

FIG. 2 is a block diagram depicting a modified alignment shifter; and

FIG. 3 is a block diagram depicting a modified shift amount calculator.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combinations thereof. In a preferred embodiment, however, the functions are performed by a processor such as a computer or an electronic data processor in accordance with code such as computer program code, software, and/or integrated circuits that are coded to perform such functions, unless indicated otherwise.

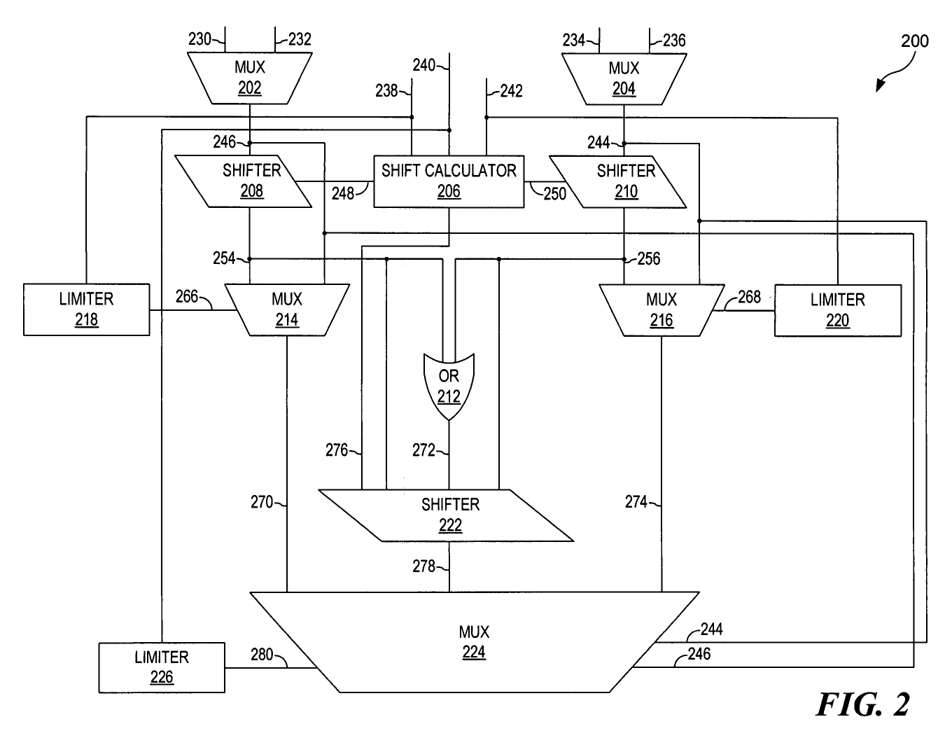

Referring to FIG. 2 of the drawings, the reference numeral 200 generally designates a modified alignment shifter. The alignment shifter 200 comprises a first mux 202, a second mux 204, a shift amount calculator 206, a first shifter 208, a second shifter 210, a first limiter 218, a third mux 214, a fourth mux 216, a second limiter 220, bitwise OR gates 212, a third shifter 222, a third limiter 226, and a fifth mux 224.

The alignment shifter 200 differs from the alignment shifter 100 in that the alignment shifter 200 can perform a double precision calculation or two simultaneous or near simultaneous single precision calculations. In other words, the alignment shifters can be configured to perform simultaneous or near simultaneous FPN alignment shifts for two single precision FPNs. Essentially, the alignment shifter 200 is a conventional double precision computation logic configured to utilize all available computational capacity. The utilization of all available computational logic is accomplished by receiving and computing either two single precision FPNs or a double precision FPN. However, the alignment shifter 200, too, is an addend to product alignment shifter.

In order for the alignment shifter 200 to function, each of the respective components must be correctly coupled to one another. The first mux 202 receives a mantissa of an addend of a first single precision FPN (MC1) or of the oth to 26^{th} bits of a double precision FPN (MC(0:26)) through a first communication channel 230 and a second communication channel 232. The first mux 202 can then select between the single precision FPN and double precision FPN based on a control signal that is also input (not shown). The second mux 204 receives a mantissa of an addend of a second single precision FPN (MC2) or of the 27^{th} to 52^{nd} bits of a double precision FPN (MC(27:52)) through a third communication channel 234 and a fourth communication channel 236. The second mux 204 can then select between the single precision FPN and double precision FPN based on a control signal that is also input (not shown). The exponents of the product and addend of the first single precision FPN (EA1, EB1, and EC1) are input to the shift amount calculator 206 and to the first limiter 218 through a fifth communication channel 238. The exponents of the product and addend of the second single precision FPN (EA2, EB2, and EC2) are input to the shift amount calculator 206 and to the second limiter 220 through a sixth communication channel 242. The exponents of the product and addend of the double precision FPN (EA, EB, and EC) are input to the shift amount calculator 206 and to the third limiter 226 through a seventh communication channel 240. Additionally, the output of the first mux 202 is transmitted to the first shifter 208 through an eight communication channel 246, and the output of the second mux 204 is transmitted to the second shifter 210 through a ninth communication channel 244.

Once the proper data has been received, then computations can begin. Based on whether two single precision FPNs or a double precision FPN is communicated to the alignment shifter 200, the shift amount calculator 206 produces either a single shift amount or two shift amounts. If there are two single precision FPNs, then a right shift amount, which can range from 0 to 63 bits, for the first single precision FPNs is transmitted to the first shifter 208 through a tenth communication channel 248 and a right shift amount, which can range from 0 to 63 bits, for the second single precision FPNs is transmitted to the second shifter 210 through an eleventh communication channel 250. However, if there is a double precision FPN, both shift amounts are the same. A right shift amount for the oth to 26^{th} bits of the mantissa of the addend is transmitted to the first shifter 208 through the tenth communication channel 248 while the right shift amount for the 27^{th} to 52^{nd} bits of the mantissa of the addend is transmitted to the second shifter 210 through the eleventh communication channel 250. Thus, the shifters 208 and 210 can produce shifted mantissa that are 90 bits long.

Once the shift amounts for either the single precision FPNs or the double precision FPN have been calculated, the functionality between the single precision FPN calculation and the double precision calculation begin to deviate. If there is a computation for a double precision number, there is overlap of the bits from the respective shifters. The outputs of the first shifter 208 and the second shifter 210 are input into the bitwise OR gates 212 and the third shifter 222 through a twelfth communication channel 254 and the a thirteenth communication channel 256, respectively. The result from the bitwise OR gate 212 is also transmitted to the third shifter 222 through a fourteenth communication channel 272 along with additional right shift amount data produced by the shift amount calculator 206 which is transmitted through a fifteenth communication channel 276. Hence, the data from the shifters 208 and 210 are ORed to eliminate overlapping bits so that the resultant data has the same right amount.

Once all of the double precision data has been received by the third shifter 222, further computations are completed. The bits complied from the shifters 208 and 210 and the bitwise OR gates 212 are shifted again by the third shifter 222 by 0, 64, or 128 bits. The third shifter 222 then outputs a signal to the fifth mux 224 through a sixteenth communication channel 278. Additionally, the fifth mux 224 receives limiter data through a seventeenth communication channel 280 and data to be used in case of overflow/underflow through the eight communication channel 246 and the ninth communication channel 244, respectively. Limiter data is provided by the third limiter 226, which checks whether the shift amount is in the appropriate range based on the exponents of the products and of addend of the double precision FPN, and is transmitted to the third limiter 226 through the seventh communication channel 240. The output of the fifth mux 224 is then an aligned addend of the mantissa of the double precision FPN.

If, on the other hand, there are two single precision computations, then other independent functions take place. The first shifter 208 produces a shifted mantissa of the addend of the first single precision FPN that is transmitted to the third mux 214 through a twelfth communication channel 254. However, the first limiter 218 also produces limiter data that is transmitted to the third mux 214 through an eighteenth communication channel 266. The limiter data for the first single precision FPN is based on the exponents of the products and of the addend of the first single precision FPN which are transmitted to the first limiter 218 through the fifth communication channel 238. Also, the third mux 214 receives overflow/underflow data for the first single precision FPN through the eighth communication channel 246. The third mux 214 can then provide the final 64 bit shift and select the appropriate data if there is underflow/overflow. Simultaneously (or near simultaneously), the second shifter 210 produces a shifted mantissa of the addend of the second single precision FPN that is transmitted to the fourth mux 216 through the thirteenth communication channel 256. However, the second limiter 220 also produces limiter data that is transmitted to the fourth mux 216 through a nineteenth communication channel 268. The limiter data for the second single precision FPN is based on the exponents of the products and of the addend of the second single precision FPN which are transmitted to the second limiter 220 through the sixth communication channel 242. Also, the fourth mux 216 receives overflow/underflow data for the second single precision FPN through the ninth communication channel 244. The fourth mux 216 can then provide the final 64 bit shift and select the appropriate data if there is underflow/overflow.

The outputs of the third mux 214 and the fourth mux 216 are then effectively, the completed computations. The third mux 214 and the fourth mux 216, though, do not simply output data directly. Data resulting from the third mux 214 and the fourth mux 216 are transmitted to the fifth mux 224 through a twenty-sixth communication channel 270 and a twenty-eighth communication channel 274, respectively. The fifth mux 224 can then merge the two single precision result into a wider resultant vector (not shown. The selection for the fifth mux 224 is also base on a control signal (not shown).

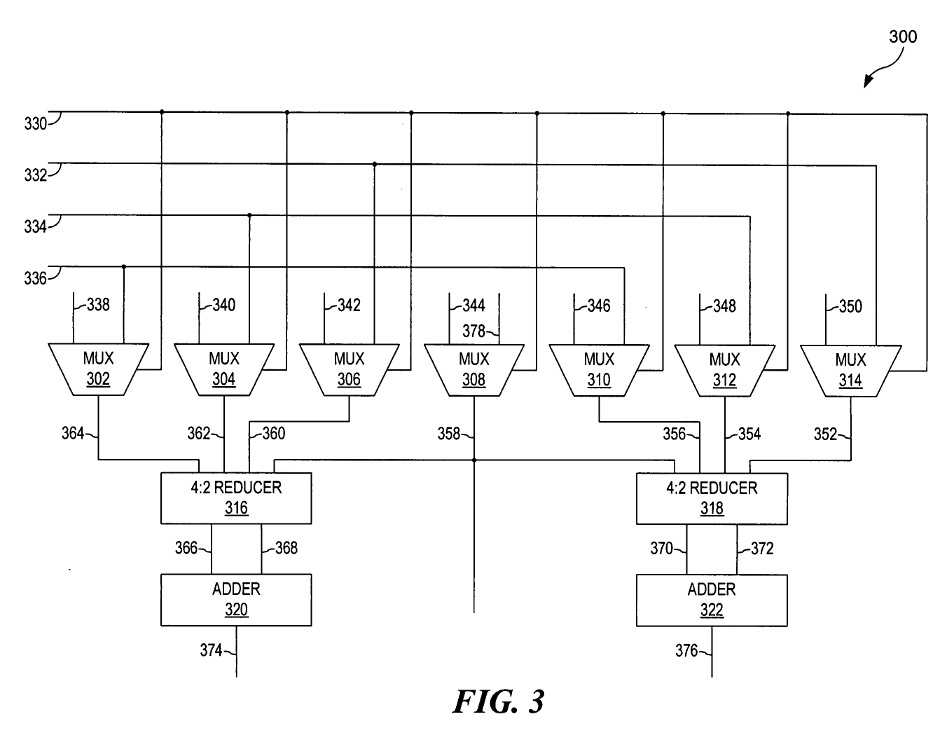

In order for the alignment shifter 200 to function, the shift amount calculator, such as the shift amount calculator 102, must be reconfigured. Referring to FIG. 3 of the drawings, the reference numeral 300 generally designates a reconfigured shift amount calculator. The reconfigured shift amount calculator 300 comprises a first mux 302, a second mux 304, a third mux 306, a fourth mux 308, a fifth mux 310, a sixth mux 312, a seventh mux 314, a first 4:2 reducer 316, a second 4:2 reducer 318, a first adder 320, and a second adder 322.

The function of the shift amount calculator 300 varies depending on whether single precision FPNs or a double precision FPN is/are utilized. A selection signal to inform the shift amount calculator 300 which type of FPN is being operated on is communicated to the first mux 302, the second mux 304, the third mux 306, the fourth mux 308, the fifth mux 310, the sixth mux 312, and the seventh mux 314 through a first communication channel 330, allowing each of the muxes to select between single precision FPNs and a double precision FPN. Also, the shift amount calculator 300 functions by generating a shift amount (sha) that is calculated by the following:
sha=EA+EB+!EC+constant. (1)

EA is the exponent for an operand of the product. EB is the exponent for another operand of the product, and !EC is the negation of the exponent of the addend. Also, the constant is dependent the given design and on whether there is a single precision or double precision calculation.

Once the selection between single precision and double precision calculation has been made, then data can be properly allocated and operated on. If there is a double precision calculation, the double precision constant is transmitted to the fourth mux 308 through a second communication channel 378; otherwise, the single precision constant is transmitted to the fourth mux 308 through a third communication channel 344. Also, for double precision calculation an exponent for an operand of the product, an exponent for another operand of the product, and the negation of the exponent of the addend are transmitted to the first mux 302 and the fifth mux 310 through a fourth communication channel 336, to the second mux 304 and the sixth mux 312 through a fifth communication channel 334, and to the third mux 306 and the seventh mux 314 through a sixth communication channel 332, respectively.

However, if there are two single precision FPN calculations, then each value is individually transmitted. An exponent for an operand of the product of the first single precision FPN is transmitted to the first mux 302 through a seventh communication channel 338. An exponent for another operand of the product of the first single precision FPN is transmitted to the second mux 304 through an eighth communication channel 340. A negated exponent for the addend of the first single precision FPN is transmitted to the third mux 306 through a ninth communication channel 342. An exponent for an operand of the product of the second single precision FPN is transmitted to the fifth mux 310 through a tenth communication channel 346. An exponent for another operand of the product of the second single precision FPN is transmitted to the sixth mux 312 through an eleventh communication channel 348. A negated exponent for the addend of the second single precision FPN is transmitted to the seventh mux 314 through a twelfth communication channel 350.

Once all of the exponents have been transmitted to the respective muxes, the data can then be further modified. The output of the first mux 302, of the second mux 304, of the third mux 306, and of the fourth mux 308 are transmitted to the first 4:2 reducer 316 through a thirteenth communication channel 364, a fourteenth communication 362, a fifteenth communication channel 360 and a sixteenth communication channel 358, respectively. The output of the fifth mux 310, the sixth mux 312, the seventh mux 314, and the fourth mux 308 to the second 4:2 reducer 316 through a seventeenth communication channel 356, an eighteenth communication channel 354, a nineteenth communication channel 352 and the sixteenth communication channel 358, respectively. The output of the first 4:2 reducer is transmitted to the first adder 320 through a twentieth communication channel 366 and a twenty-first communication channel 368, and the output of the second 4:2 reducer is transmitted to the second adder 322 through a twenty-second communication channel 370 and a twenty-third communication channel 372. Once all data is transmitted to the adders, the first adder 320 outputs an 8 bit signal through a twenty-fourth communication channel 374, while the second adder 322 outputs a 6 bit signal through a twenty-fifth communication channel 376. Additionally, the 2 most significant bits are transmitted to the third shifter 222 (FIG. 2) through the sixteenth communication channel 358.

The combination of components, therefore, produces a favorable result. By allowing two single precision FPN computations to take place on the same logic that can perform double precision calculations, overall latency can be reduced, and area can be reduced. In the traditional computational logic, a single precision FPN calculation was performed by a double precision logic. However, computational space was wasted. The utilization of available computational capacity allows for simultaneous or near simultaneous calculation of multiple single precision FPN computations, which reduces the number of queued computations that increases overall speed. Moreover, because of the overall increase in usage, it is possible to reduce the number of computational logic blocks that would decrease the size or allow for the placement of additional, complementary functional blocks on the wafer.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. An apparatus for performing alignment shifts for a Floating Point (FP) operation, comprising a double precision alignment shifter with at least one stage that is at least configured to perform at least one alignment shift per stage for a double precision FP operation and that is configured to perform at least two alignment shifts per stage for at least two single precision FP operations.

2. The apparatus of claim 1, wherein the double precision alignment shifter is at least configured to select between the at least one alignment shift for a double precision FP operation and the at least two alignment shifts for at least two single precision FP operations.

3. The apparatus of claim 2, wherein the double precision alignment shifter further comprises:
a plurality of first multiplexers (muxes) that are at least configured to operate on approximately one-half of the bits of the double precision FP operation or on at least one first set of bits associate with one single precision operation; and
a plurality of second muxes that are at least configured to operate on approximately one-half of the bits of the double precision FP operation or on at least one second set of bits associate with one single precision operation.

4. The apparatus of claim 2, wherein the double precision alignment shifter further comprises a shift amount calculator that calculates at least one shift amount based on bit associated with the double precision FP operation or bits associated with at least two single precision FP operations.

5. The apparatus of claim 4, wherein the double precision alignment shifter further comprises a plurality of shifters that are at least configured to perform shifting based on the at least one shift amount.

6. A method for employing a double precision alignment shifter, comprising:
selecting between a double precision FP operation and two single precision FP operations;
if the double precision FP operation is selected, performing an alignment shift by the double precision alignment shifter on a set of bits associated with the double precision FP operation; and
if the two single precision FP operations are selected, performing an alignment shift by the double precision alignment shifter on a set of bits associated with the two single precision FP operations.

7. The method of claim 6, wherein the step of performing an alignment shift by the double precision alignment shifter on a set of bits associated with the double precision FP operation further comprises:
dividing the set of bits associated with the double precision FP operation into at least two smaller sets of bits;
calculating at least one shift amount for the double precision FP operation;
shifting each of the at least two smaller sets of bits based on the at least one shift amount to produce at least two shifted sets; and
bitwise ORing the at least two shifted sets.

8. The method of claim 6, wherein the step of performing an alignment shift by the double precision alignment shifter on a set of bits associated with the two single precision FP operations further comprises:
calculating at least one shift amount for the two single precision FP operations; and
shifting each of the at least two smaller sets of bits based on the at least one shift amount to produce at least two shifted sets.

9. A computer program product for employing a double precision alignment shifter, the computer program product having a medium with a computer program embodied thereon, the computer program comprising:
computer code for selecting between a double precision FP operation and two single precision FP operations;
if the double precision FP operation is selected, computer code for performing an alignment shift by the double precision alignment shifter on a set of bits associated with the double precision FP operation; and
if the two single precision FP operations are selected, computer code for performing an alignment shift by the double precision alignment shifter on a set of bits associated with the two single precision FP operations.

10. The computer program product of claim 9, wherein the computer code for performing an alignment shift by the double precision alignment shifter on a set of bits associated with the double precision FP operation further comprises:
computer code for dividing the set of bits associated with the double precision FP operation into at least two smaller sets of bits;
calculating at least one shift amount for the double precision FP operation;
shifting each of the at least two smaller sets of bits based on the at least one shift amount to produce at least two shifted sets; and
bitwise ORing the at least two shifted sets.

11. The computer program product of claim 9, wherein the computer code for performing an alignment shift by the double precision alignment shifter on a set of bits associated with the two single precision FP operations further comprises:
computer code for calculating at least one shift amount for the two single precision FP operations; and
computer code for shifting each of the at least two smaller sets of bits based on the at least one shift amount to produce at least two shifted sets.

12. A processor for employing a double precision alignment shifter, the processor including a computer program comprising:
computer code for selecting between a double precision FP operation and two single precision FP operations;
if the double precision FP operation is selected, computer code for performing an alignment shift by the double precision alignment shifter on a set of bits associated with the double precision FP operation; and
if the two single precision FP operations are selected, computer code for performing an alignment shift by the double precision alignment shifter on a set of bits associated with the two single precision FP operations.

13. The computer program of claim 12, wherein the computer code for performing an alignment shift by the double precision alignment shifter on a set of bits associated with the double precision FP operation further comprises:
computer code for dividing the set of bits associated with the double precision FP operation into at least two smaller sets of bits;
calculating at least one shift amount for the double precision FP operation;
shifting each of the at least two smaller sets of bits based on the at least one shift amount to produce at least two shifted sets; and
bitwise ORing the at least two shifted sets.

14. The computer program of claim 12, wherein the computer code for performing an alignment shift by the double precision alignment shifter on a set of bits associated with the two single precision FP operations further comprises:
computer code for calculating at least one shift amount for the two single precision FP operations; and
computer code for shifting each of the at least two smaller sets of bits based on the at least one shift amount to produce at least two shifted sets.
